(19) United States
(12) Patent Application Publication
(10) Pub. No.: US 2023/0051301 A1
(43) Pub. Date: Feb. 16, 2023

(54) FIBER ENHANCED EPOXY AND DELIVERY SYSTEM

(71) Applicant: Robert K. Hughes, JR., Cape Coral, FL (US)

(72) Inventor: Robert K. Hughes, JR., Cape Coral, FL (US)

(21) Appl. No.: 17/740,732

(22) Filed: May 10, 2022

Related U.S. Application Data
(60) Provisional application No. 63/232,703, filed on Aug. 13, 2021.

(51) Int. Cl. C09J 163/00; C09J 11/04

(52) U.S. Cl. CPC C09J 163/00; C09J 11/04; C09J 2400/14

(57) ABSTRACT

A two-part fiber reinforced epoxy and delivery system having at least one tube containing one component of a two-part epoxy, the tube having an enlarged opening for dispensing strengthening fibers through the enlarged opening mixed with the one component of the two-part epoxy.

### CROSS REFERENCE TO RELATED APPLICATION

This application claims priority from U.S. provisional patent application Ser. No. 63/232,703 filed Aug. 13, 2021, the entirety of which is incorporated herein by reference.

### FIELD OF INVENTION

The present invention relates generally to an epoxy system, and more specifically to a fiber enhanced epoxy and system or method for delivery of fiber enhanced epoxy.

### BACKGROUND

Two-part epoxy is a well known and popular solution for structural repairs and for use as an adhesive. The components of such two-part epoxy formulas include a liquid hardener that is added to a liquid resin. When mixed together and cured, the components yield an epoxy resin that is easy to pour into molds or shape into desired forms. The mixture is also available in a wide variety of formulas for use as an adhesive and coating. The cure time is typically short, and the resulting epoxy resin may be further worked, whether by any necessary sanding or drilling, for example.

When used in marine applications, or other applications requiring additional strength in the resulting material, the mixed but still pre-cured epoxy mixture is often used to cover, coat or be imbedded with, an additional strengthening material. Such strengthening materials may include carbon fibers or fiberglass. When the epoxy mixture is used with a strengthening material, the material may be laid down as woven fiberglass layer covering a weak location in a boat hull, after which the epoxy mixture is then coated over or to cover the woven fiberglass layer. Alternatively, carbon fibers may be added to the pre-mixed but not yet set, solidified or cured epoxy mixture, which are then together deposited over the desired location.

Unfortunately, because such two-part formulas must be mixed with the proper amount of each component, incorporating the strengthening materials requires an additional step for added mixing. An improved system to deliver strengthening materials within a two-part epoxy is desired. The present application provides a fiber enhanced epoxy and delivery system that addresses these prior disadvantages.

### SUMMARY

A two-part epoxy and delivery system is provided with at least one of the two components of the two-part formula including the strengthening materials pre-mixed with the formula component, to enable combined delivery of the strengthening materials when the two components of the two-part epoxy are combined together. It should be understood that while strengthening materials are provided pre-mixed within one of the two part components, it is also possible to include strengthening materials in both components of the two-part formula. Either the same or different strengthening materials may be provided in each of the components, as desired to obtain the necessary strength in the resulting epoxy resin material.

The difficulty with delivery of the two components of such two-part formulas is that different amounts of each component of the formula are required to obtain the final cured product. Typically, a larger amount of the resin component is used compared to a smaller amount of the hardener component. It should also be understood that each resin component and hardener component may be a blend of a variety of fillers and/or additives, such as modifiers or pigments, which are added to each component to obtain the desired performance in the resulting epoxy. One such example is U.S. Pat. No. 8,278,398, which is incorporated herein by reference.

There are a variety of delivery systems currently available for such two-part formulas of epoxy resin. One system conventionally used to deliver the components of a two-part epoxy includes providing individual containers of each component, with appropriately sized dispensers to dose the proper amount of each component from the individual containers, which may then be mixed in a separate container. The West System® of epoxy resin manufactured by Gougeon Brothers, Inc. in Bay City, Minn., www.westsystem.com, is a common example of such a delivery system.

Another delivery system approach is to provide a dual tube cartridge, or syringe, within a gun style applicator, where different sized tubes within a cartridge are used to simultaneously drive the proper amount of each component from each tube using the gun or plunger applicator. Such cartridges and gun style applicator systems may include mixing nozzles to deliver the mixed components directly to the desired location. A number of such systems are available under a variety of brand names from 3M Company, St. Paul, Minn., www.3m.com, as well as from other manufacturers. The present fiber enhanced epoxy may be used with either of these delivery system approaches.

### DESCRIPTION OF DRAWINGS

FIG. 1 schematically illustrates a prior art tube of one component of a two-part component formula for epoxy resin.

FIG. 2 schematically illustrates a tube of one component of the present application for a two-part component epoxy resin formula with strengthening materials included in the one illustrated component.

FIG. 3 schematically illustrates a dual gun style application delivery system including the improved fiber enhanced epoxy prior to delivery.

FIG. 4 schematically illustrates the improved fiber enhanced epoxy delivered to a site for use as an adhesive requiring added strength.

### DETAILED DESCRIPTION

Although the following detailed description contains many specific details for purpose of illustration, it is understood that one of ordinary skill in the art will appreciate that many examples, variations and alterations to the following description are within the spirit and scope of the disclosure. Like references numerals refer to similar elements throughout.

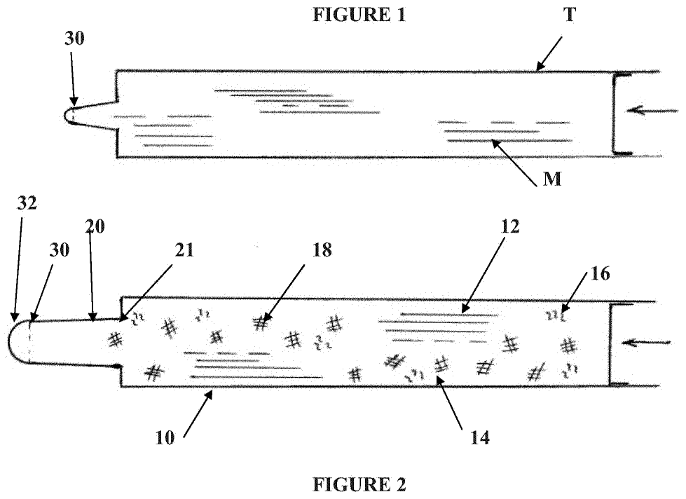

FIG. 1 schematically illustrates a prior art single tube T containing one component material M of two components of the two-part epoxy formula. Referring to

FIGS. 2 to 4, aspects of the fiber enhanced epoxy system and delivery system are shown.

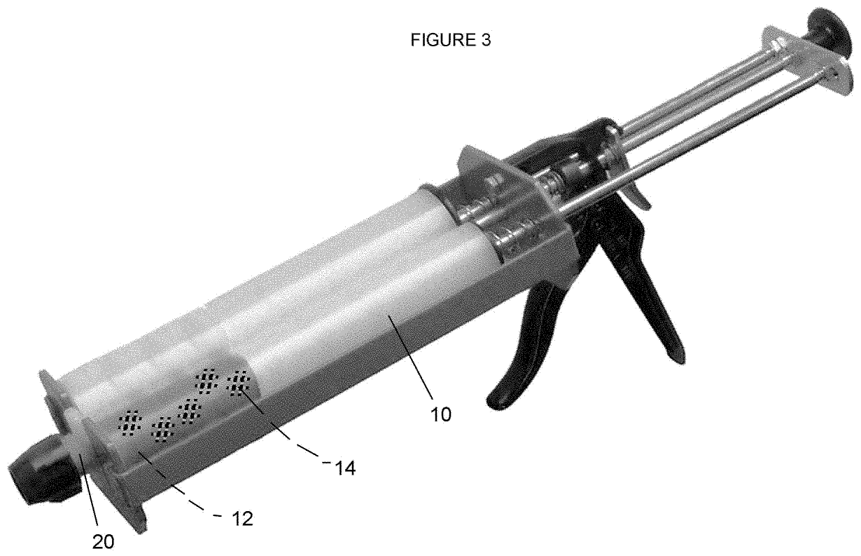

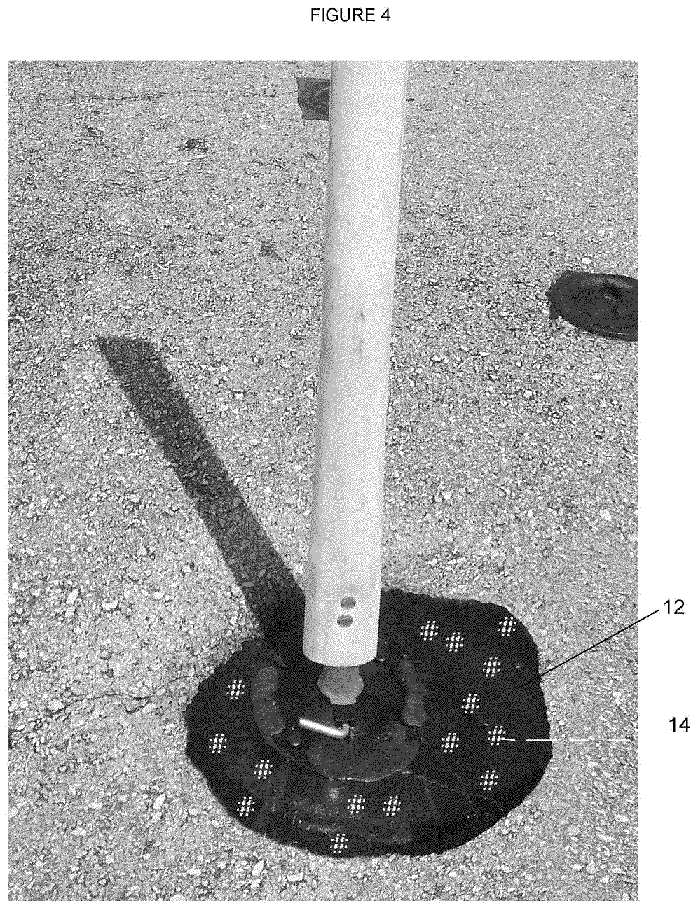

As shown in FIG. 2, a schematic illustration of the present fiber enhanced epoxy system provides a tube 10 of one component material 12 including strengthening material 14, whether the strengthening material is either, or both, carbon fibers 16 or fiberglass material 18. To accommodate the size and delivery of the strengthening materials through tube nozzle 20, the present system provides both a larger diameter tube opening 21 and a larger diameter nozzle 20 for delivery of both the component material 12 and the strengthening material(s) 14. The enlarged tube opening 21 and nozzle 20 are at least twice the diameter of prior art tube openings and nozzles, or of a pre-determined size resisting clogging of the tube openings and the nozzles during dispensing of the component mixed containing the strengthening fibers 14. The ends of the nozzles shown in FIGS. 1 and 2 each indicate a cut line 30, where to open the nozzle, the tip 32 of the nozzle at the cut-line is removed to dispense the component materials. The fiber enhanced epoxy component material may be provided as a single tube, as shown, or as a dual tube cartridge of the type shown in FIG. 3, where the tube containing the strengthening materials within the cartridge has the larger diameter tube opening and larger diameter nozzle for clog-free delivery of the strengthening materials. Where both component materials are provided with strengthening materials, it is understood that both tubes are provided with larger diameter tube openings and nozzles for ease of delivery of the strengthening materials using the delivery system.

Where large amounts of mixed two-part, pre-mixed epoxy resin with strengthening material is desired to be delivered, for example for use in building and highway construction projects, as shown in one example in FIG. 4, large sized containers (1 gallon, 5 gallon, 55 gallon, or a train car or truck tanker container, for example) may be provided. In such applications, the large containers of material are supplied with large nozzles and/or pumping systems to direct the proper amount of each component, where at least one or both of the formula components includes the pre-mixed carbon fiber or fiberglass material. As shown in FIG. 2, the fiberglass material 18 may be provided as individual fibers, or as smaller pieces of woven fiberglass fabric material dispersed within the component. For example, the smaller pieces of woven fiberglass may be provided as small as 1/32 inch squares, ⅛ inch squares or 1 inch squares, but larger sizes of material, up to and including a 12 inch square or strips, of fiberglass material may also be used. Testing has revealed that the addition of pieces of woven fiberglass material to either or both of the epoxy components impart additional strength to the cured epoxy resin.

While the present fiber enhanced epoxy and system has been disclosed in detail sufficient for one of ordinary skill in the art to practice the invention, it should be understood that various changes, substitutions and alterations may be made without departing from the spirit or scope of the device as defined in the attached claims.

Moreover, the scope of the present epoxy and system is not intended to be limited to the specific embodiments described here, which are provided by way of example. As one of ordinary skill in the art will readily appreciate from the present disclosure and embodiments, other components presently existing or later to be developed that perform substantially the same function to achieve substantially the same result as those of the corresponding embodiments described here, may be utilized according to the present application. Accordingly, the appended claims are intended to include within their scope such other devices/systems and components.

I claim:

1. A two-part epoxy and delivery system having at least one tube containing one component of a two-part epoxy, the tube having an enlarged opening for dispensing strengthening fibers through the enlarged opening mixed with the one component of the two-part epoxy.

2. The two-part epoxy and delivery system of claim 1, wherein the strengthening fibers are carbon fibers or fiberglass.

3. The two-part epoxy and delivery system of claim 1, wherein the strengthening fibers are woven fiberglass material.

4. The two-part epoxy and delivery system of claim 1, wherein two tubes, each containing one component of the two-part epoxy, include enlarged openings for dispensing strengthening fibers through the enlarged openings mixed with the components of the two-part epoxy.

5. The two-part epoxy and delivery system of claim 4, wherein the strengthening fibers are carbon fibers or fiberglass.

6. The two-part epoxy and delivery system of claim 4, wherein the strengthening fibers are woven fiberglass material.

7. The two-part epoxy and delivery system of claim 6, wherein the strengthening fibers of woven fiberglass material are between 1/32 inch and 12 inch pieces of material.

8. An improved two-part fiber reinforced epoxy having a first component part containing either a resin component or a hardener component, wherein the first component part is pre-mixed and includes carbon fiber or fiberglass strengthening fibers.

9. The improved two-part fiber reinforced epoxy of claim 8, wherein the fiberglass is woven fiberglass material between 1/32 inch and 12 inch pieces of material along one edge.

10. The improved two-part fiber reinforced epoxy of claim 9, having a second component part containing the other of either the resin component or hardener component in the first component part, and wherein the first component and the second component parts are each provided as pre-mixed materials including carbon fiber or fiberglass strengthening fibers.

11. An improved two-part fiber reinforced epoxy and two-part epoxy delivery system, the two-part epoxy delivery system having at least one tube containing a first component part of the two-part fiber reinforced epoxy of either a resin component or a hardener component, wherein the first component part is pre-mixed and includes carbon fiber or fiberglass strengthening fibers, and the at least one tube having an enlarged opening for dispensing strengthening fibers through the enlarged opening mixed with the first component part of the two-part fiber reinforced epoxy.

12. The improved two-part fiber reinforced epoxy and two-part epoxy delivery system of claim 11, having a second tube containing a second component part of the two-part fiber reinforced epoxy with the other of either the resin component or hardener component in the first component part, and wherein the first component and the second component parts are each provided as pre-mixed materials including carbon fiber or fiberglass strengthening fibers, and the second tube having an enlarged opening for dispensing strengthening fibers through the enlarged opening mixed with the second component part of the two-part fiber reinforced epoxy.

13. The improved two-part fiber reinforced epoxy and two-part epoxy delivery system of claim 12, wherein the fiberglass is woven fiberglass material between 1/32 inch and 12 inch pieces of material along one edge.
